(19) United States
(12) Patent Application Publication
(10) Pub. No.: US 2003/0169740 A1
(43) Pub. Date: Sep. 11, 2003

(54) Method and apparatus for transmitting and receiving data

(76) Inventors: John M. Harris, Chicago, IL (US); Robert D. Battin, Kildeer, IL (US); Dan Zhang, Vernon Hills, IL (US)

Correspondence Address: MOTOROLA, INC., 1303 EAST ALGONQUIN ROAD, IL01/3RD, SCHAUMBURG, IL, 60196

(21) Appl. No.: 10/093,552

(22) Filed: Mar. 8, 2002

(51) Int. Cl. H04L 12/28; H04L 12/56

(52) U.S. Cl. 370/394; 370/392; 370/335

(57) ABSTRACT

Each frame (500) being transmitted and received contains two frame sequence numbers. The first frame sequence number (501) comprises the sequence number of the frame being transmitted, while the second frame sequence number (502) comprises the sequence number of the next expected frame being received by the transmitter. Because each frame (500) contains a sequence number for the next expected data frame (502), transmitting circuitry (301, 302) will more quickly realize if a particular frame has not been received by the receiver. This reduces the number of idle frames needed to be transmitted at the end of the data session.

### FIELD OF THE INVENTION

The present invention relates generally to transmitting and receiving data, and in particular, to a method and apparatus for transmitting and receiving data within a wireless communication system.

### BACKGROUND OF THE INVENTION

In current Code Division Multiple Access (CDMA) communication systems a Radio Link Protocol (RLP) is utilized for the link layer to transport data traffic between a mobile unit and infrastructure equipment. RLP is a Negative-Acknowledgment (NAK) based protocol in that the receiver does not acknowledge correctly-received RLP frames. In-order delivery is accomplished with the use of a sequence number (SEQ) for each frame. During two-way communication, each mobile, or remote unit maintains a counter for the sequence number of the next new data frame to send [SEQ(S)] and a counter for the sequence number of the next new data frame it expects to receive [SEQ(R)]. RLP requests the retransmission of RLP frames when a frame is received with a sequence number greater than the next expected sequence number (SEQ(R)). Retransmission is accomplished by sending a NAK to the transmitter identifying the sequence number of the frame not received. Prior to receiving the NAK'd frame, subsequently transmitted RLP frames continue to be received by the receiver.

FIG. 1 illustrates the current RLP NAK procedure. Although FIG. 1 illustrates transmission from unit 101 and reception by unit 102, it should be noted that in many instances unit 102 is also transmitting data to unit 101 utilizing an independent RLP procedure, having independent sequence numbers.

As shown frames 101 are transmitted by a transmitter over the air and are received by a receiver as frames 102. During over-the-air transmission, oftentimes data is lost and needs to be retransmitted to the receiver. This is illustrated in FIG. 1 as frame F3 being lost. Upon receiving frame F4, the receiver immediately realizes that frame F3 is missing and requests retransmission of F3 by sending a NAK to the transmitter. Upon reception of the NAK, the transmitter immediately retransmits F3 to the transmitter.

A problem arises when the last data frame transmitted in a bearer data burst (e.g. an upload or download) by the transmitter is not received. In this situation, the receiver will receive no subsequent frames so the receiver will not find out the last data frame was never received, unless/until another bearer frame is sent by the transmitter. More particularly, because RIP determines lost frames by a break in frame sequence number, the receiver needs to receive subsequently transmitted frames in order to determine if a frame has not been received.

In order to solve this problem, prior art systems transmit a predetermined number of idle frames after the last data frame is transmitted. The idle frames comprise a frame number equal to the next frame number in the sequence of data frames. This is illustrated in FIG. 2. As shown in FIG. 2, the last data frame sent (F4) is followed by a series of idle frames (I5) and when F3 is retransmitted, the series of idle frames also follow. When the receiver receives the idle frame I5, it knows that the data transmission has ended, and that F4 is the highest data frame transmitted to the receiver.

Although sending idle frames solves the above-mentioned problem, another problem arises in that the transmission of idle frames negatively impacts radio frequency (RF) and network capacity. In particular, because a CDMA system is a self-interfering system, all transmissions over the system result in added system interference, network capacity load, and in some cases Mobile Subscriber (MS) battery drain. Therefore, a need exists for a method and apparatus for data transmission that allows a receiver to know when a last data frame has not been received, yet reduces the amount of system interference and network capacity loading relative to prior-art systems.

### BRIEF DESCRIPTION OF THE DRAWINGS

FIG. 1 illustrates prior-art data transmission.

FIG. 2 illustrates prior-art data transmission.

FIG. 3 is a block diagram of a communication system in accordance with the preferred embodiment of the present invention.

FIG. 4 illustrates a transmission scheme in accordance with the preferred embodiment of the present invention.

FIG. 5 is a frame structure in accordance with the preferred embodiment of the present invention.

FIG. 6 is a flow chart showing operation of the communication system of FIG. 3 in accordance with the preferred embodiment of the present invention.

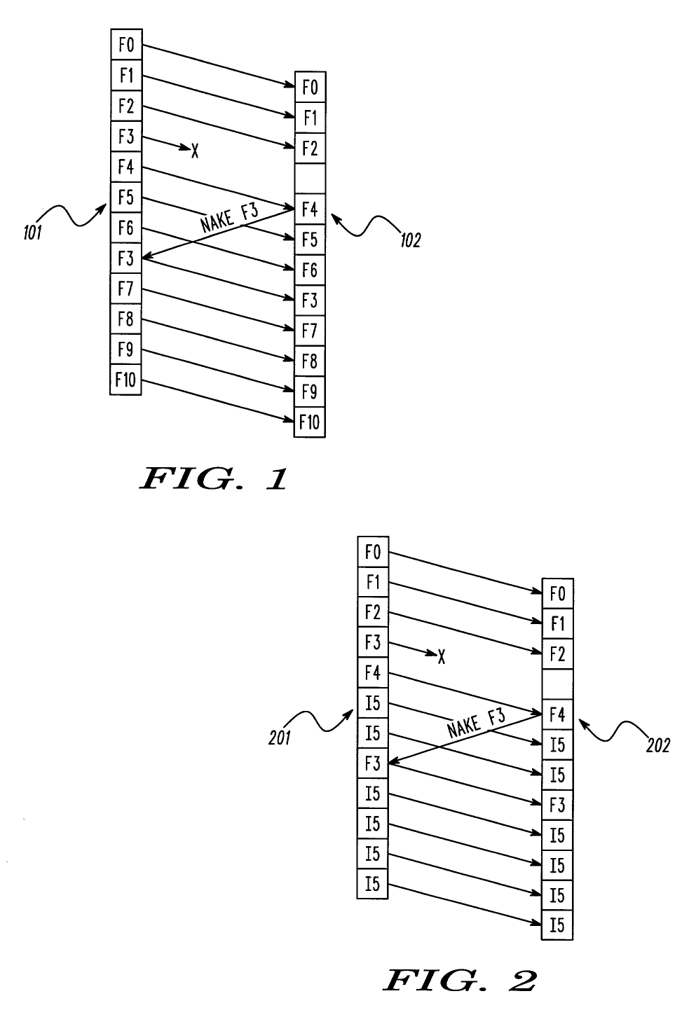

### DETAILED DESCRIPTION OF THE DRAWINGS

In order to address the above-mentioned need, a method and apparatus for transmitting data is provided herein. In accordance with the preferred embodiment of the present invention each frame being transmitted and received contains two frame sequence numbers. The first frame sequence number comprises the sequence number of the frame being transmitted, while the second frame sequence number comprises the sequence number of the next expected frame being received by the transmitter.

Because each frame contains a sequence number for the next expected data frame, transmitting circuitry will more quickly realize if a particular frame has not been received by the receiver. This reduces the number of idle frames needed to be transmitted at the end of the data session.

The present invention encompasses a method comprising the steps of receiving a first set of data having a first series of frame sequence numbers and transmitting a second set of data comprising a second series of frame sequence numbers and the first series of frame sequence numbers.

The present invention additionally encompasses a frame comprising a first frame sequence number from a first data transmission session, a second frame sequence number from a second data transmission session, and data from the first data transmission session while containing no data from the second data transmission session.

The present invention additionally encompasses a method comprising the steps of receiving a first plurality of frames, the first plurality of frames comprising a first series of sequence numbers, and transmitting a second plurality of frames, the second plurality of frames comprising a second series of sequence numbers differing from the first plurality of sequence numbers, the second plurality of frames additionally comprising the first series of sequence numbers.

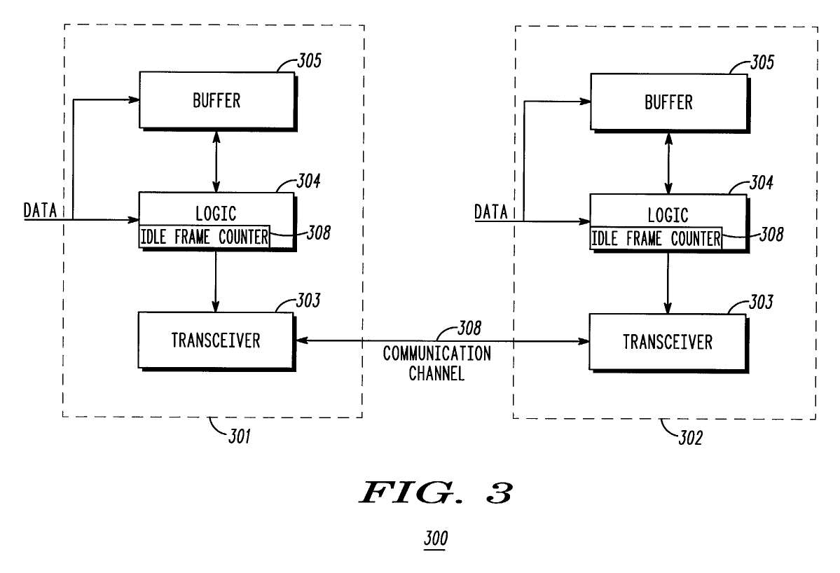

Turning now to the drawings, wherein like numerals designate like components, FIG. 3 is a block diagram of communication system 300 in accordance with the preferred embodiment of the present invention. As shown, communication system 300 comprises transceiving circuitry 301 and transceiving circuitry 302. Transceiving circuitry 301/302 is preferably a CDMA Radio Access Network such as a Motorola SC Centralized Base Site Controller, a Motorola SC 4800 Base Transceiver System, or a mobile, or cellular handset such as a Motorola StarTAC®.

During operation data enters logic unit 304 and buffer 305. The data is passed from logic unit 304 to transceiver 303 where it is transmitted over communication channel 308. The CDMA over-the-air protocol utilizes RLP. As discussed above, RLP is a Negative-Acknowledgment based protocol in that the receiver does not acknowledge correctly-received RLP frames. Therefore, on the receiving side, transceiver 303 only requests the retransmission of missing RLP frames by sending a NAK to the sender. In particular, when a frame is received out of sequence, logic circuitry 304 will instruct transceiver 303 to NAK the improperly received (or un-received) frame. The NAK will be transmitted over communication channel 308 and received by the sender (via a transceiver 303).

The NAK is eventually received by logic unit 304, and logic unit 304 retrieves the lost frame from buffer 305 and instructs transceiver 303 to retransmit the frame. Once all data has been transmitted, logic unit 304 instructs transceiver 303 to transmit a predetermined number (N) of idle frames having a sequence number incremented from the last frame sent. More particularly, if the last data frame sent had sequence number M, then N idle frames are transmitted, each having sequence number M+1. In order to keep track of the number of idle frames transmitted, logic unit 304 utilizes idle frame counter 308.

As discussed above, although sending idle frames are necessary, a problem arises in that the transmission of idle frames negatively impacts radio frequency (RF) capacity and network capacity. In order to address this problem, all frames transmitted will additionally contain an RLP sequence number for the next expected RLP frame. Therefore a receiver of the transmitted data will receive each frame with the RLP sequence number of that data session along with an RLP sequence number from another data session, that being the RLP sequence number expected from the receiver when the receiver transmits data to the sender. In other words, frames transmitted by transceiver 303 will contain RLP sequence numbers for two data transmission sessions. The first RLP sequence number will be the RLP sequence number for the current data session being transmitted (SEQ(S)), and the second RLP sequence number will be the RLP sequence number for the next expected sequence in the current data session being received (SEQ(R)).

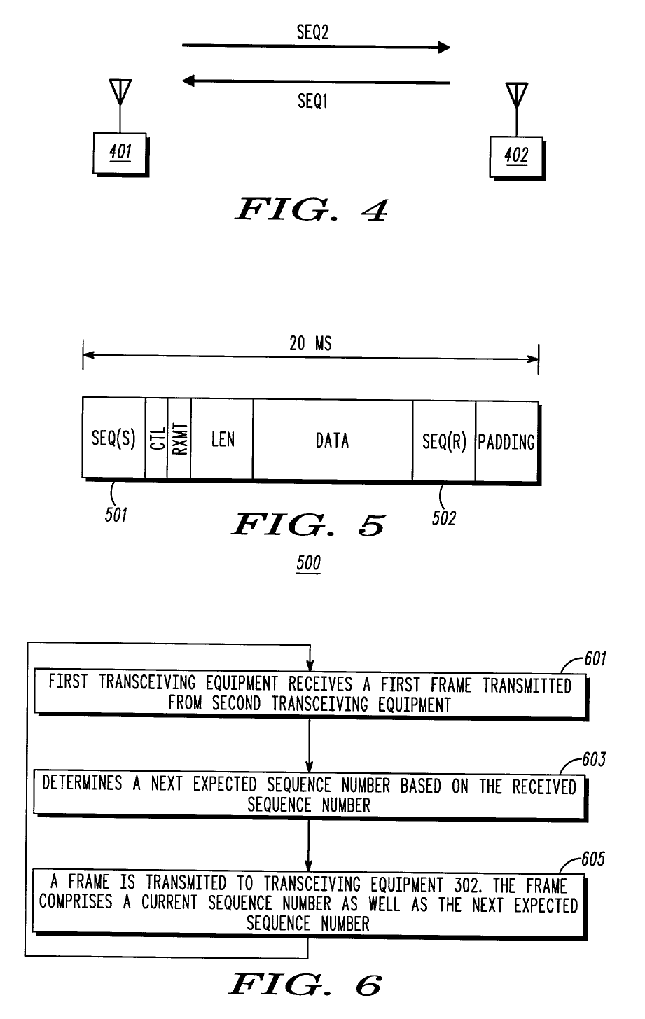

The present transmission scheme is illustrated in FIG. 4. As shown both units 401 and 402 are transmitting and receiving data. Unit 401 receives data from unit 402 and also transmits data to unit 402. Similarly, unit 402 receives data transmitted from unit 401 and transmits data to unit 401. Each data transmission contains its own unique RLP sequence numbers. Therefore, the data frames transmitted from unit 401 contains a first series of sequence numbers (e.g., . . . 101, 102, 103, . . . ), and the data frames received by unit 401 (transmitted from 402) contains a second series of sequence numbers (e.g., . . . 21, 22, 23, . . . . ) independent of the first series of sequence numbers. As discussed above, each data frame additionally carries a sequence number for the next expected sequence number of the data being received. So, for example, if unit 401 is currently transmitting a frame with a sequence number of 101, and has just received a frame with a sequence number of 22, (next expected=23) then the current frame transmitted to unit 402 would contain sequence numbers 101 and 23. Thus, during operation a transceiver will receive a first plurality of frames containing a first series of sequence numbers while simultaneously transmitting a second plurality of frames containing both the first series of sequence numbers and the second series of sequence numbers. Because of this, unit 402 will more quickly realize if a particular frame has not been received by unit 401. This reduces the number of idle frames needed to be transmitted at the end of the data session.

FIG. 5 and Table 1 illustrates frame structure in accordance with the preferred embodiment of the present invention. It should be noted that although FIG. 5 illustrates unsegmented data frame 500 containing both SEQ(S) 501 and SEQ(R) 502, in alternate embodiments of the present invention frames containing both SEQ(S) and SEQ(R) may be segmented data frames, fill frames, idle frames, and NAK frames. As discussed above, the frame structure will comprise two data transmission sequence numbers.

TABLE 1
Unsegmented Data Frame Format

| Field | Length (bits) |
|---|---|
| SEQ(S) | 8 |
| CTL | 1 |
| REXMIT | 1 |
| LEN | 6 |
| Data | 8xLEN |
| SEQ(R) | 8 |
| Padding | Variable |

In the preferred embodiment of the present invention the SEQ(S) field contains the least significant 8 bits of the data frame's sequence number. For a new data frame, the data frame's sequence number is L_V(S) (as described in section 4.3.1.1 of TIA/EIA/IS-707-A-2.3). For a retransmitted data frame, the data frame's sequence number is the same as when the frame was transmitted as a new data frame. For a frame carrying unsegmented data the CTL field is be set to ‘0’. The REXMIT field is set to ‘1’ when the frame is a retransmitted data frame; otherwise, it is set to ‘0’. The LEN field indicates data length, and may be any value in the range from 1 to the maximum allowable for the data frame. As discussed above, SEQ(R) is the sequence number for the next expected sequence in the current data session being received. Finally, the padding field is utilized to fill the remainder of the frame. These bits are set to ‘0’.

FIG. 6 is a flow chart showing operation of the communication system of FIG. 3 in accordance with the preferred embodiment of the present invention. The logic flow begins at step 601 where first transceiving equipment 301 receives a first frame transmitted from second transceiving equipment 302. As discussed above, the received frame contains a first sequence number. At step 603 logic unit 304 determines a next expected sequence number based on the received sequence number. At step 605 a frame is transmitted to transceiving equipment 302. The frame comprises a current sequence number as well as the next expected sequence number. The logic flow then returns to step 601. Thus in accordance with the preferred embodiment of the present invention, the transceiver will receive a first set of data having a first series of frame sequence numbers, while transmitting a second set of data having both the first series of frame sequence numbers and a second series of frame sequence numbers.

As discussed above, because each frame contains a sequence number for the next expected data frame, transmitting circuitry will more quickly realize if a particular frame has not been received. This reduces the number of idle frames needed to be transmitted at the end of the data session.

It should be noted that in some instances a greater amount of data within frames will not allow for the addition of the second sequence number. In these situations the frame format is similar to that described in TIA/EIAIS-707-A-2.3. Therefore, in accordance with the preferred embodiment of the present invention, logic circuitry 304 will analyze each frame transmitted to determine if enough space exists within the frame to include SEQ(R) prior to adding the field. Similarly, if additional space exists within the frame, other RLP parameters may be included along with SEQ(R). For example, L_V(N), which is the oldest missing SEQ number on the receiver side, can be reported to the sender to help the in determining when older frames can be released from memory reducing the memory requirements of the system.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method comprising the steps of:
receiving a first set of data having a first series of frame sequence numbers; and
transmitting a second set of data comprising a second series of frame sequence numbers and the first series of frame sequence numbers.

2. The method of claim 1 wherein the step of transmitting the second set of data additionally comprises the step of transmitting the second set of data comprising a sequence number of an oldest missing frame.

3. The method of claim 1 wherein the step of receiving the first set of data having the first series of frame sequence numbers comprises the step of receiving the first set of data having a first series of Radio Link Protocol (RLP) frame sequence numbers.

4. The method of claim 1 wherein the step of transmitting the second set of data comprises the step of transmitting a Negative Acknowledgment (NAK).

5. A frame comprising:
a first frame sequence number from a first data transmission session;
a second frame sequence number from a second data transmission session; and
data from the first data transmission session while containing no data from the second data transmission session.

6. The frame of claim 5 wherein the first frame sequence number comprises a Radio Link Protocol (RLP) frame sequence number.

7. The frame of claim 6 wherein the second frame sequence number comprises an RLP frame sequence number.

8. The frame of claim 5 wherein the first data transmission session comprises data being transmitted.

9. The frame of claim 8 wherein the second data transmission session comprises data being received.

10. A method comprising the steps of:
receiving a first plurality of frames, the first plurality of frames comprising a first series of sequence numbers; and
transmitting a second plurality of frames, the second plurality of frames comprising a second series of sequence numbers differing from the first plurality of sequence numbers, the second plurality of frames additionally comprising the first series of sequence numbers.

11. The method of claim 10 wherein the step of transmitting the second plurality of frames additionally comprises the step of transmitting the second plurality of frames containing a sequence number of an oldest missing frame.

12. The method of claim 10 wherein the step of receiving a first plurality of frames comprises the step of receiving the first plurality of frames having a first series of Radio Link Protocol (RLP) frame sequence numbers.

13. The method of claim 10 wherein the step of transmitting the second plurality of frames comprises the step of transmitting a plurality of Negative Acknowledgments (NAK).
